(19) United States
(12) Patent Application Publication
(10) Pub. No.: US 2004/0080652 A1
(43) Pub. Date: Apr. 29, 2004

(54) Electric camera

(76) Inventors: Shinichi Nonaka, Chigasaki (JP); Toshiro Kinugasa, Hiratsuka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/615,786

(22) Filed: Jul. 10, 2003

(30) Foreign Application Priority Data
Jul. 25, 2002 (JP) 2002-216008

(51) Int. Cl. H04N 3/14; H04N 5/335

(52) U.S. Cl. 348/321; 348/312

(57) ABSTRACT

An image pick-up device includes a driving unit to drive an image sensor in such a manner as to read a long-time exposed imaging signal having a long exposure time and a short-time exposed imaging signal having a short exposure time from the image sensor, and a signal processing unit to generate an image signal by synthesizing and processing a signal representing the low-brightness portion of the long-time exposed imaging signal and a signal representing the high-brightness portion of the short-time exposed imaging signal.

### BACKGROUND OF THE INVENTION

The present invention relates to a dynamic image pick-up device using an image sensor such as a CCD image sensor, or in particular to a technique for picking up a dynamic image having a wider dynamic range than the original sensitivity of an image sensor.

In picking up an image of an object with an image pick-up device using an image sensor like a CCD image sensor, the operating point of the image sensor is optimized by adjusting the exposure time of the image sensor in such a manner that the proper signal level of the object is secured by measuring the brightness of the object from an imaging signal.

In the case where the technique for optimizing the operating point of an image sensor is used in the image pick-up device described above, the problem described below is posed when the brightness distribution of the object to be imaged extends over a wide range.

Assume, for example, that the exposure time is set in such a manner as to secure the proper signal level of the high brightness portion of an object. The signal of the low brightness portion would be deformed, and therefore the resolution of the low brightness portion becomes difficult to secure. Conversely, assume that the exposure time is set to secure the proper signal level of the low brightness portion of the object. The signal of the high brightness portion would be saturated, and the image of the particular portion would be simply whitened, thereby making it impossible to distinguish the object.

### SUMMARY OF THE INVENTION

An object of the present invention is to provide an image pick-up device having a wide dynamic range which is capable of generating an image of an object faithfully even in the case where the brightness distribution of the object to be imaged extends over a wide range.

In order to achieve the object described above, there is provided an image pick-up device comprising a driving unit for driving an image sensor in such a manner as to read a long-time exposure imaging signal having a long exposure time and a short-time exposure imaging signal having a short exposure time from the image sensor, and a signal processing unit for generating a single image signal by synthesizing and processing the signal of the low brightness portion of the long-time exposure time imaging signal and the signal of the high brightness portion of the short-time exposure imaging signal.

### BRIEF DESCRIPTION OF THE DRAWINGS

These and other features, objects and advantages of the present invention will become apparent from the following description when taken in conjunction with the accompanying drawings wherein:

FIG. 1 shows an example of an embodiment of this invention;

FIG. 2 shows an example of a CCD image sensor unit according to the embodiment shown in FIG. 1;

FIG. 3 shows read pulse waveforms of the pixel storage charge at the time of normal imaging according to the embodiment shown in FIG. 1;

FIG. 4 shows the result of mixing pixels and an array of output signals at the time of normal imaging according to the embodiment shown in FIG. 1;

FIGS. 5A to 5D are diagrams for explaining the generation of an image having a wide dynamic range;

FIGS. 6A and 6B show the timing of reading the pixel storage charge for both the exposure control at the time of normal imaging and the exposure control at the time of dynamic-range imaging according to the embodiment shown in FIG. 1;

FIG. 7 shows read pulse waveforms for the pixel storage charge at the time of wide dynamic-range imaging according to the embodiment shown in FIG. 1;

FIG. 8 shows the result of mixing pixels and an array of output signals at the time of wide dynamic-range imaging according to the embodiment of FIG. 1;

FIGS. 9A to 9D are diagrams for explaining the matching of the angle of view of the picked-up image according to the embodiment of FIG. 1;

FIG. 10 shows an example of an embodiment of the invention different from the embodiment shown in FIG. 1; and

FIG. 11 shows an example of drive pulses for reading the imaging signal from the pixels during the vertical transfer period according to the embodiment of FIG. 1.

### DESCRIPTION OF THE EMBODIMENTS

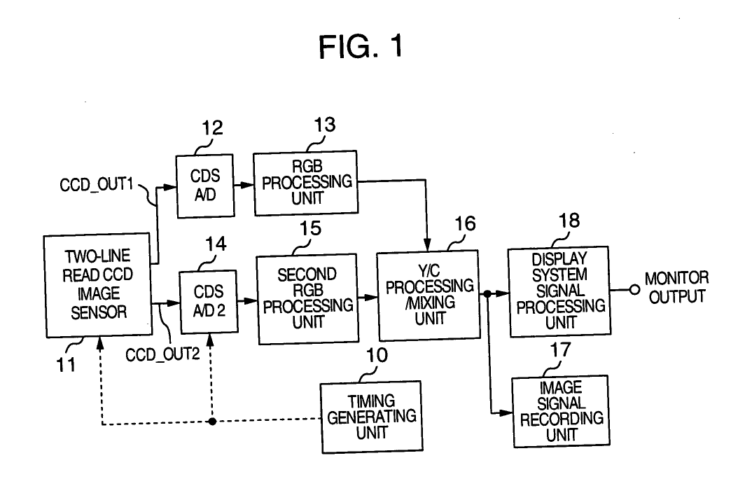

FIG. 1 is a block diagram showing an example of an image pick-up device according to an embodiment of this invention. In FIG. 1, reference numeral 11 designates a CCD image sensor unit, numeral 12 a CDS (correlated double sampling) A/D conversion unit, numeral 13 a RGB processing unit, numeral 14 a second CDS A/D conversion unit, numeral 15 a second RGB processing unit, numeral 16 a Y/C processing/mixing unit, numeral 17 an image signal recording unit, numeral 18 a display system signal processing unit, and numeral 10 a timing generating unit.

An embodiment of the invention will be explained below with reference to FIG. 1 and several other supplementary diagrams.

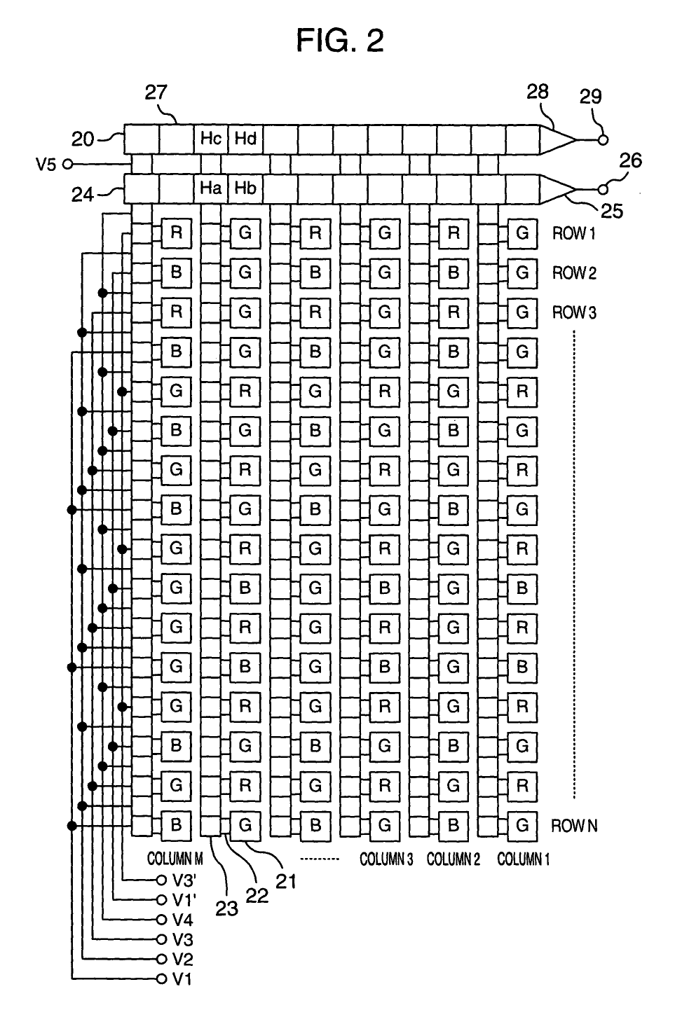

FIG. 2 is a diagram showing a structural model of an example of the CCD image sensor unit 11 according to this invention. In FIG. 2, numeral 21 designates pixels having the function to convert light into electrical energy. In the CCD image sensor unit, a photodiode is generally used as each of the pixels 21.

In the conventional image pick-up device for dynamic imaging according to the NTSC system format, for example, the number of pixels in vertical direction is generally about 500, i.e. about twice the number 240 of effective lines in vertical direction. According to this embodiment, in contrast, the number of effective pixels in vertical direction is 960, i.e. more than four times as many as the number 240 of effective lines.

Numeral 22 designates a gate for transferring the charge stored in the pixels 21 to vertical CCDs designated by numeral 23. Generally, the drive pulse for this gate functions also as a drive pulse of the vertical CCDs 23.

Each vertical CCD 23 is driven by a four-phase gate pulse. The gate pulse assumes three values of potential levels including high, middle and low levels. The high-level pulse is supplied only to the vertical CCDs 23 driven by V1, V3, V1′, V3′, and when the gate pulse is at high level, the charge is transferred to the corresponding vertical CCD from the pixels 21. The charge is transferred in the vertical CCD 23 by supplying middle-level and low-level four-phase binary pulses to the gates of V1, V2, V3, V4, V1′, V3′.

Numerals 24 and 27 designate first and second horizontal CCDs, respectively, both of which are driven by a two-phase gate pulse to transfer the stored charge in horizontal direction in each horizontal CCD. Also, with regard to the charge transfer between the first horizontal CCDs 24 and the second horizontal CCDs 27, a transfer gate exists only in the direction from Ha to Hc in the drawing which is coupled with the vertical CCDs 23, and the transfer is possible only in the direction from Ha to Hc in FIG. 2. A potential wall exists and the transfer is impossible in the direction from Hb to Hd not coupled with the vertical CCDs 23.

Numerals 25, 28 designate first and second output amplifiers, and numerals 26, 29 first and second output terminals, respectively.

The vertical CCD's are configured of two gates per pixel. In the case where the charge of all the 960 pixels in vertical direction are read during one field period, the stored charge per two pixels in vertical direction are transferred by being added to each other. In FIG. 2, the alphabetical characters R, G, B indicated in the section representing each pixel designate the colors of color filters of the respective pixels. R designates a red filter, G a green filter, and B a blue filter.

The feature of the CCD image sensor unit 11 lies in that the horizontal CCDs for horizontal transfer are divided into two systems unlike the conventional ordinary CCD image sensor unit having only one horizontal transfer system of the horizontal CCDs. The advantage of employing two horizontal CCD systems is that signals of two lines can be read at a time in the horizontal transfer operation phase. The method of driving the image sensor unit 11, which is substantially similar to that for the conventional CCD image sensor unit of interline type, will be described below.

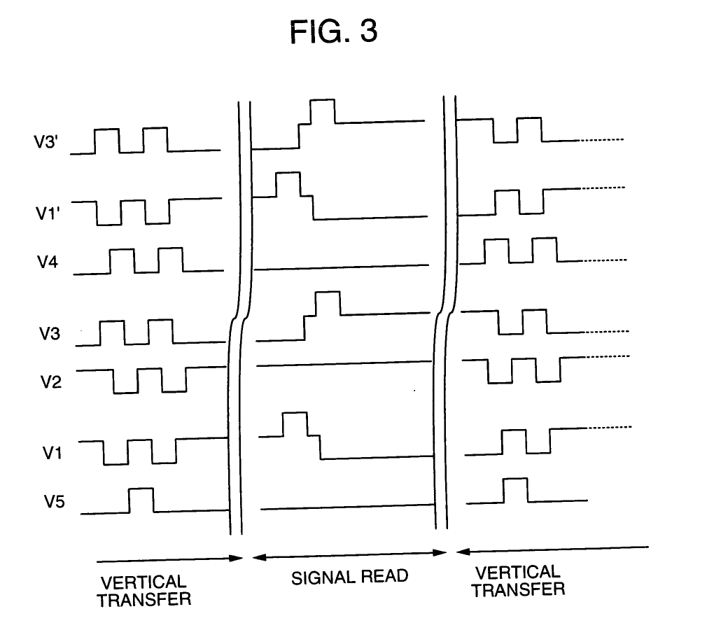

First, the stored charge is read on the vertical CCDs 23 from the pixels 21 during the blanking period of the signal. Each two lines of the stored charge read by the vertical CCDs are added to each other and transferred to the first horizontal CCDs 24. The stored charge first transferred to the first horizontal CCDs 24 is immediately transferred to the second horizontal CCDs 27. After that, when each transfer gate 20 interposed between the first horizontal CCDs 24 and the second horizontal CCDs 27 is closed, the stored charge is transferred again from the vertical CCDs 23 to the first horizontal CCDs 24. The drive pulses for the vertical CCDs 23 to perform the vertical transfer operation is shown in FIG. 3.

The charge transferred to the two horizontal CCDs 24, 27 are sequentially transferred to the first and second output amplifiers 25, 28 and read from the first and second output terminals 26, 29 as electrical signals based on voltage changes in accordance with the signal output period of the image pick-up device according to the invention.

Subsequently, the two sessions of vertical transfer and horizontal transfer described above are repeated thereby to read the charge stored in the pixels of the CCD image sensor unit. This is the basic method of driving the CCD image sensor unit according to the invention.

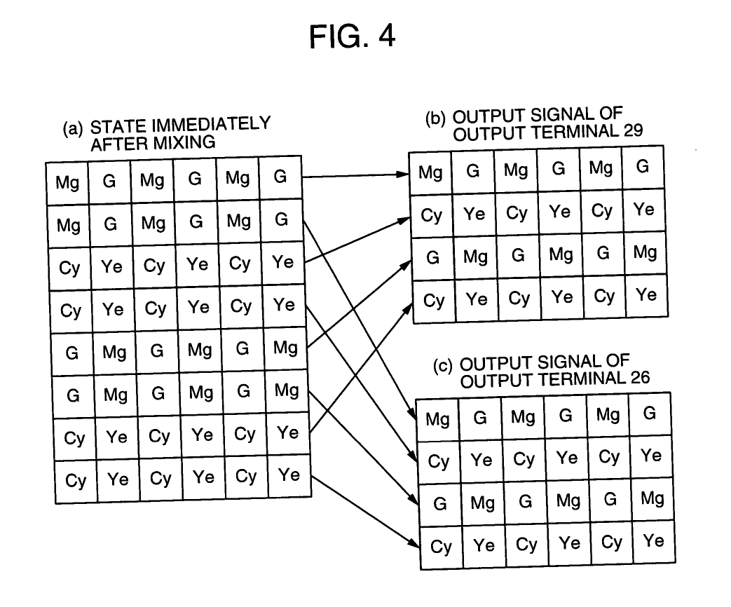

According to this driving method, the signals read from the CCD image sensor unit 11 are mixed in the vertical CCDs 23, and the charge in the vertical CCDs in an array shown in (a) of FIG. 4 are distributed into odd-numbered ones and even-numbered ones in vertical direction. Thus, the odd-numbered charge shown in (b) of FIG. 4 are read from the second output terminal 29, and the even-numbered charge shown in (c) of FIG. 4 are read from the first output terminal, as an imaging signal.

The R, G and B color filters of the CCD image sensor unit 11 are arranged with the period of 2×16 as shown in FIG. 2. Therefore, another feature of the image pick-up device according to the invention lies in that the imaging signals read from the first and second output terminals are arranged in the order of ordinary complementary colors of Bayer type.

The imaging signal (CCD_OUT1) read from the first output terminal is supplied to the first CDS/AD conversion unit 12 and converted into a digital imaging signal. This digital imaging signal is filtered in the first RGB processing unit and converted into 240 (lines/field) first digital RGB imaging signals representing the RGB three primary colors.

In similar fashion, the imaging signal (CCD_OUT2) read from the second output terminal 29 is also converted into 240 (lines/field) second digital RGB imaging signals representing the RGB three primary colors through the second CDS/AD conversion unit 14 and the second RGB processing unit 15.

The first and second digital RGB imaging signals are combined into 240 (lines/field) new digital RGB imaging signals by the Y/C processing/mixing unit 16 in the case of interline processing, and further, these new digital RGB imaging signals are converted into a brightness signal and a color difference signal.

The brightness signal and the color difference signal output from the Y/C processing/mixing unit 16 are supplied to the image signal recording unit 17 and the display system signal processing unit 18. In the image signal recording unit 17, the brightness signal and the color difference signal are recorded as an image signal, while in the display system signal processing unit 18, they are output as a monitor output in accordance with a format corresponding to the monitor connected.

The basic operation of the image pick-up device according to the invention has been described above. Now, an explanation will be given about the process for generating an image of a wide dynamic range using this image pick-up device.

The signal level of the imaging signal, i.e. the amount of the charge stored in the pixels 21 read from the CCD image sensor unit is proportional to the intensity of light reaching the pixels 21 from the object to be imaged and the time during which the pixels are exposed to light, and the distribution of the stored charge developed on the pixels 21 reflects the brightness distribution of the object to be imaged.

In view of the fact that the capacity of the charge stored in each pixel 21 has its own upper limit, however, the pixels are therefore saturated at a certain level, and even when exposed to light, the amount of the stored charge ceases to increase. In the case where the CCD image sensor unit 11 is left exposed to light without reading the charge for a long time, therefore, all the pixels 21 are saturated in an extreme case, with the result that the output signals from the CCD image sensor unit 11 are deformed.

In the case where the brightness distribution of an object extends over a wide range for an ordinary image pick-up device, therefore, the exposure is controlled by shortening the exposure time of the CCD image sensor unit 11 or discharging the stored charge to the substrate, i.e. by activating the high-speed shutter midway thereby to prevent the saturation of the charge storage of the pixels 21.

An exposure time shortened with a high-speed shutter, however, reduces the signal level of the low-brightness portion and therefore would deteriorate the S/N ratio. Also, the contrast of the low-brightness area representing a major proportion of the screen would be reduced for an object having a high-brightness portion in spots.

In order to obviate this disadvantage, with the image pick-up device according to the invention, two picked-up images are prepared, including an image picked up by a long-time exposure and an image picked up by a short-time exposure. These two images are sliced each at an arbitrary signal level, and the signal representing the high-brightness portion imaged by a short-time exposure and the signal representing the low-brightness portion imaged by a long-time exposure are combined with each other to produce an image.

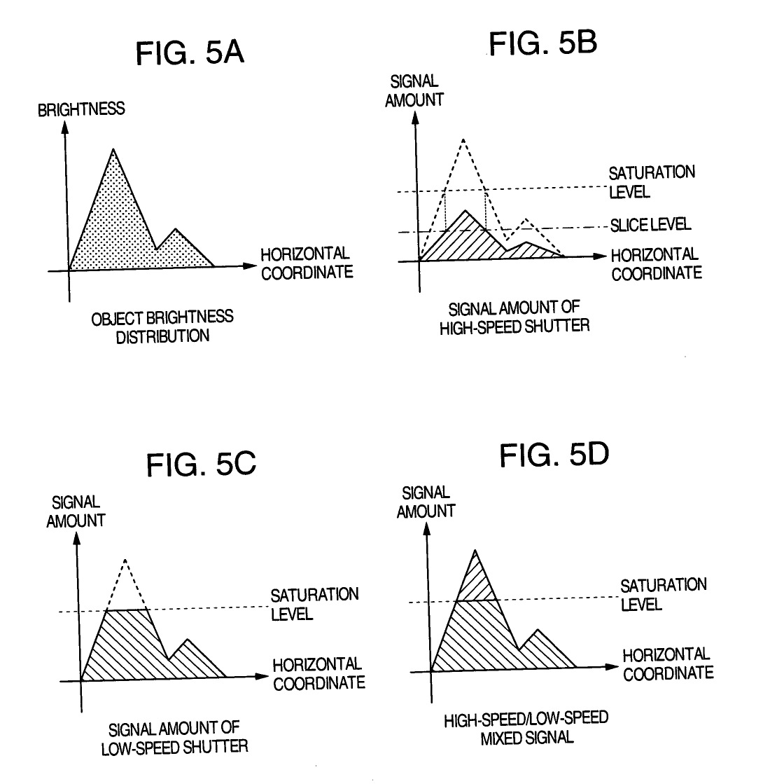

The manner in which the signals are combined in the way described above is shown in FIGS. 5A to 5D, which will be explained briefly below.

Now, assume that the brightness distribution of a given horizontal line of a picked-up image is as shown in FIG. 5A. Also assume that the level change of the image signal for the short-time exposure is as shown in FIG. 5B, and the level change of the image signal for the long-time exposure is as shown in FIG. 5C.

Examination of FIG. 5B shows that the image signal for the long-time exposure is saturated at the high-brightness portion of the object and therefore fails to reflect the brightness distribution of the object faithfully.

In order to reproduce the saturated portion, therefore, the corresponding portion is cut out of the image picked up by the short-time shutter and, after being multiplied by an appropriate factor, the result is added to the image picked up by the low-speed shutter.

As a result, a picked-up image signal faithfully representing the brightness distribution of the object is obtained as shown in FIG. 5D.

In the image pick-up device according to the invention, this series of operation is performed by the Y/C processing/mixing unit 16.

It was explained above that in the image pick-up device according to the invention, an image picked up by the long-time exposure and an image picked up by the short-time exposure are coupled with each other in an appropriate form to generate a picked-up image having a wide dynamic range. Now, an explanation will be given about a method of retrieving an image picked up by the long-time exposure and an image picked up by the short-time exposure with an image pick-up device according to the invention.

With an image pick-up device according to the invention, the image picked by the long-time exposure and the image picked up by the short-time exposure can be obtained at the same time in one field scan read step only by slightly changing the method of driving the CCD image sensor unit 11.

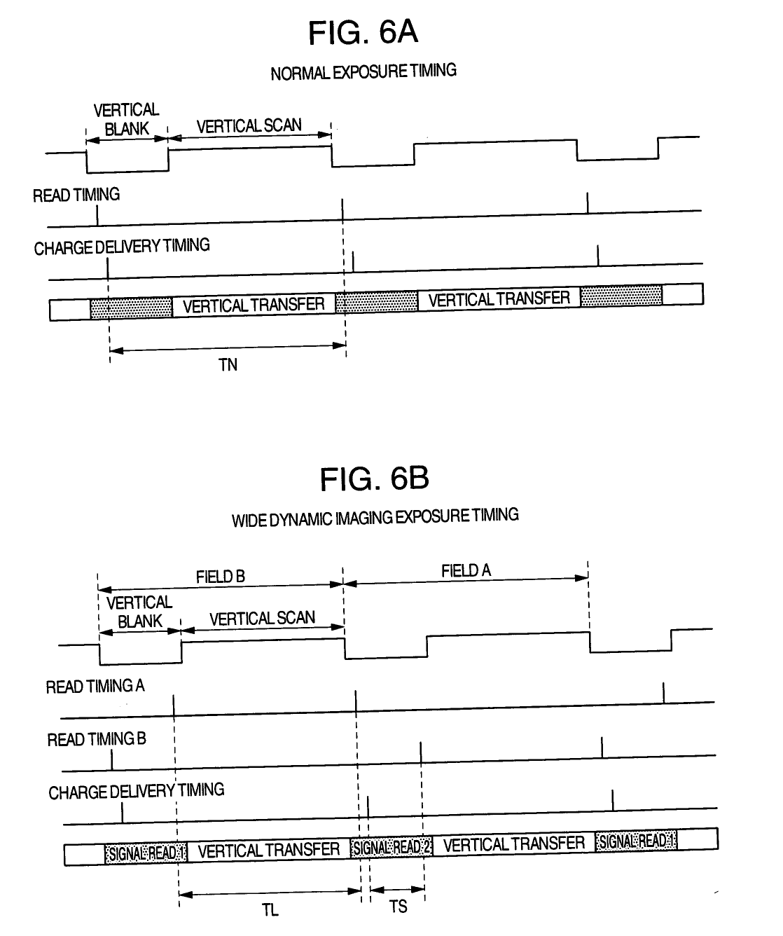

FIGS. 6A and 6B show an approximate timing of reading the stored charge on the vertical CCD unit 23 from the pixels 21, i.e. an approximate timing of raising V1, V1′, V3, V3′ to high level, in the sequence of retrieving a picked-up image with an image pick-up device according to the invention.

For reading the stored charge from the normal pixels, the stored charge is read on the vertical CCD 23 from the pixels 21 during the blanking period as shown in FIG. 6A.

In this case, the exposure time lasts from the charge delivery timing at which the charge is delivered onto the substrate from the pixels 21 to the read timing at which the stored charge is read from the pixels 21 on the vertical CCD 23. In other words, the exposure time is represented by TN in FIG. 6A.

In the image pick-up device according to the invention, on the other hand, it is already explained that two picked-up images distributed into two vertical lines of the CCD image sensor unit 11 can be obtained in one field scan. Utilizing this fact, the two images picked up by the long-time exposure and the short-time exposure, i.e. the two images having different exposure time are obtained in one field scan by reading the signals in such a manner as to switch the exposure time TN for each two vertical lines of the CCD image sensor unit 11. For this purpose, the CCD image sensor unit 11 is driven in the manner described below.

FIG. 6B shows an approximate timing with the read timing is changed for every two lines.

In FIG. 6B, the read timing changed for each two lines are designated as the read timing A and the read timing B, respectively.

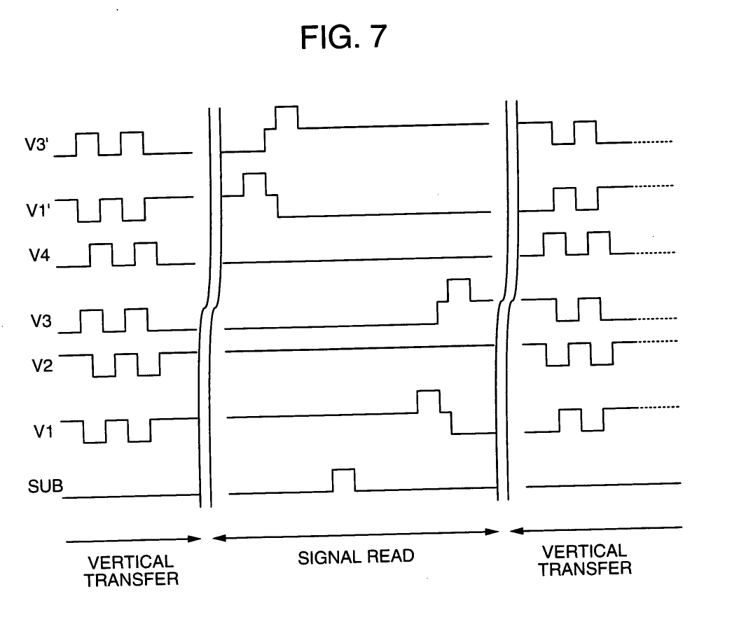

FIG. 7 shows an approximate form of the drive pulse for the CCD image sensor unit 11 corresponding to the read timing 2 in FIG. 6B in the case where the read timing A is taken at the timing of reading the charge with V1, V3 and the read timing B is taken at the timing of reading the charge with V1′, V3′. In FIG. 7, the pulses designated by SUB represent a pulse waveform for delivering the charge to the substrate from the pixels 21.

Now, let us consider the reading of the charge during a period corresponding to the read timing 2 in FIG. 6B.

The exposure time of the pixels 21 read at the read timing A is given as TL lasting from the read timing A included in the immediately preceding read timing 1 to the read timing A included in the read timing 2 under consideration.

The exposure time of the pixels 21 read at the read timing B, on the other hand, is given as TS lasting from the time point of charge delivery included in the period of the read timing 2 under consideration to a subsequent time point when the read operation is performed at read timing B.

In this case, the relation holds that TL>TS indicating that the charge stored by the short-time exposure and the charge stored by the long-time exposure are read on the vertical CCDs 23 alternately for each two lines.

Under this condition, the pixels having the charge stored by the short-time exposure are mixed with the pixels having the charge stored by the long-time exposure, and the charge is read out. In this way, the imaging signal obtained by the long-time exposure is read from the first output terminal 26, while the imaging signal obtained by the short-time exposure is read from the second output terminal 29.

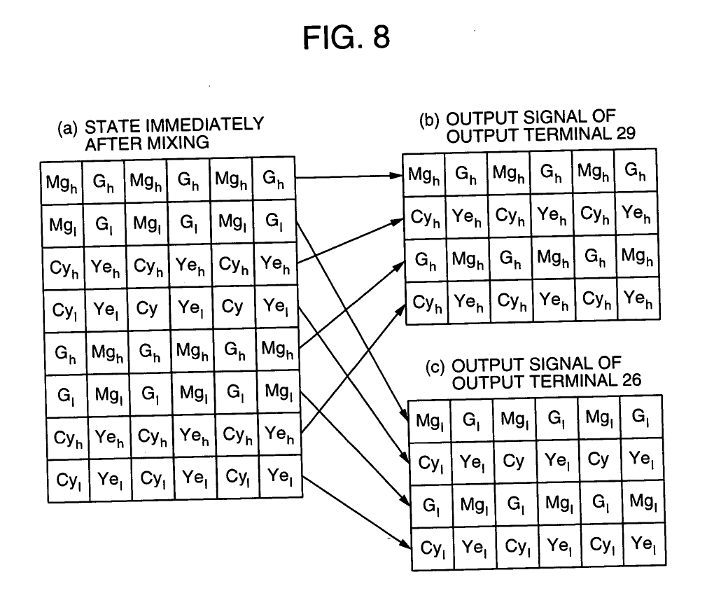

FIG. 8 shows an arrangement of the charge ((a) of FIG. 8) developed on the vertical CCDs 23 immediately after mixing the pixels and the relation between the signals ((c) of FIG. 8) read from the first output terminal 26 and the signals ((b) of FIG. 8) read from the second output terminal 29. As seen from this diagram, in the image pick-up device according to the invention, the signals are read from the CCD image sensor unit 11 in such a manner that the timing of reading the charge on the CCDs 23 from the pixels 21 is distributed, for each two lines, before and after the charge delivery timing during the vertical blanking period, thereby making it possible to obtain two types of imaging signals having different exposure time in one field scan.

The images generated from the two imaging signals produced by the aforementioned method of driving the CCD image sensor unit 11 are offset with each other by 0.5 lines in vertical direction. In the case where the first and second digital RGB imaging signals generated from the two imaging signals are added to each other, therefore, one of the two signals is preferably offset by 0.5 lines.

Next, the process for offsetting one of the first and second digital RGB imaging signals in the image pick-up device according to the invention will be explained.

At the exposure timing for imaging with a wide dynamic range shown in FIG. 6B, assume that the field where the charge read on the vertical CCDs 23 from the pixels 21 at the signal read timing 1 is read from the first and second output terminals of the CCD image sensor unit 11 is referred to as a field A, and the field where the charge read on the vertical CCDs 23 from the pixels 21 at the signal read timing 2 is read from the first and second output terminals of the CCD image sensor unit 11 is referred to as a field B.

Further, assume that the signals read from the first and second output terminals are offset from each other by 0.5 lines in vertical direction, and therefore, for the convenience' sake, the signals read from the second output terminal 29 are numbered 0.5, 1.5, 2.5 and so on for each line, while the signals read from the first output terminal 26 are numbered 1.0, 2.0, 3.0 and so on for each line.

Under these conditions, let us consider the signals to be output by the image pick-up device according to the invention in the case where the format of the brightness signal and the color difference signal output from the same image pick-up device is assumed to be that of NTSC system.

In the NTSC system, the scanning line of the display screen is switched for each of an odd field and an even field. Thus, an image is displayed on the screen by conducting the even-numbered line scanning in the even field and the odd-numbered line scanning in the odd field.

Now, assume that the field A is an even field and the field B an odd field in FIG. 6B. The brightness signal and the color difference signal according to the NTSC system are output in the case where the image pick-up device sequentially outputs the brightness signal and the color difference signal on lines 1.0, 2.0, 3.0 and so forth corresponding to the lines indicated by the signals output from the first output terminal in the field A on the one hand and the brightness signal and the color difference signal on lines 0.5, 1.5, 2.5 and so forth corresponding to the lines indicated by the signals output from the second output terminal in the field B on the other hand.

Thus, in the image pick-up device, the image signal obtained from the second output terminal 29 is offset during the period of the field A and the image signal obtained from the first output terminal 26 is offset during the period of the field B, followed by synthesis of an image having a wide dynamic range, and the image thus synthesized is out by being converted into the brightness signal and the color difference signal.

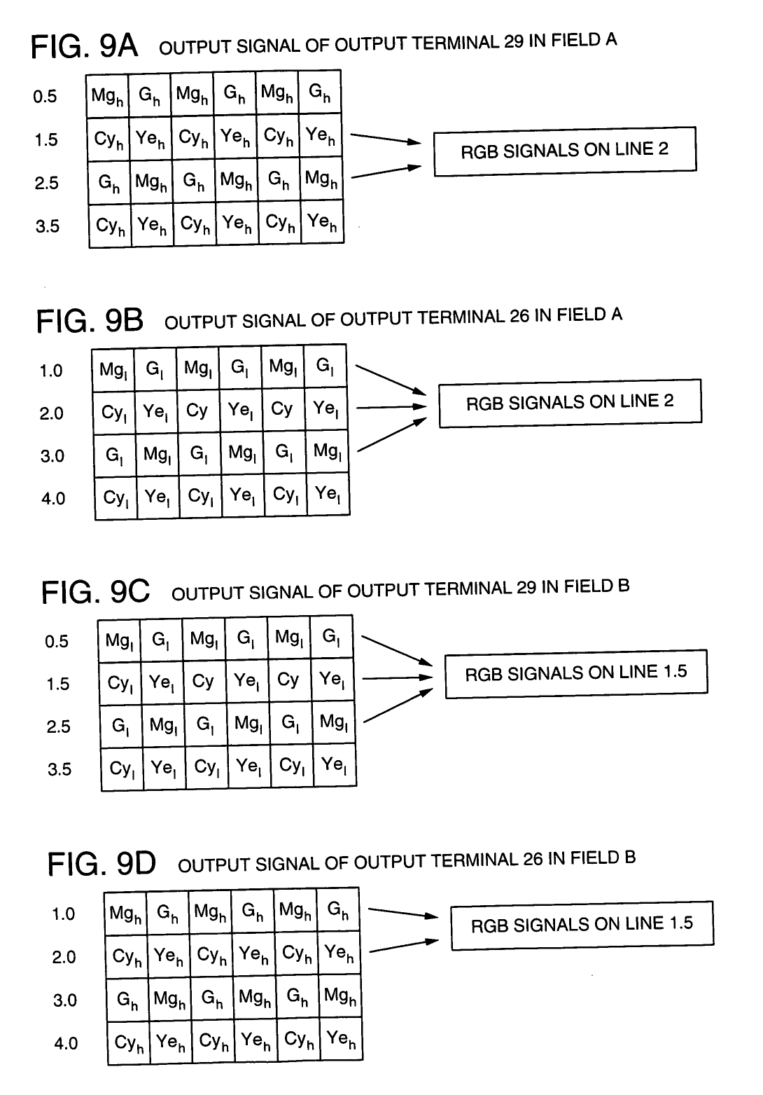

FIGS. 9A to 9D are diagrams schematically showing the process of generating the RGB image signals offset with respect to lines 2 and 1.5. This diagram will specifically be explained below.

The RGB image signals on line 2 in the field A are generated in such a manner that the RGB image signal on line 2 to be offset is generated by filtering from the imaging signals on lines 1.5 and 2.5 as shown in FIG. 9A, while the RGB signal on line 2 not to be offset is generated by filtering from the imaging signals on line 2.0 and two adjoining lines as shown in FIG. 9B.

The RGB image signals on line 1.5 in the field B, on the other hand, are generated in such a manner that the RGB image signal on line 1.5 not to be offset is generated by filtering from the imaging signals on line 1.5 and two adjoining lines as shown in FIG. 9C, while the RGB imaging signal on line 1.5 to be offset is generated by filtering from the imaging signals on lines 1.0 and 2.0 as shown in FIG. 9D.

As the result of the aforementioned line processing, the existence of the four color imaging signals of Mg, G, Cy, Ye in the filtering process makes it apparent that the imaging signals can be converted into the imaging signals of RGB three primary colors.

The process of generating the RGB imaging signals shown in FIGS. 9A to 9D is executed by processing three lines for the signal not to be offset and two lines for the signal to be offset. Alternatively, the signals to be offset may be processed on five lines and the signals not to be offset on four lines.

Apart from the foregoing process, a signal interpolation unit may be inserted between the RGB processing unit 15 and the Y/C processing/mixing unit 16. Then, without offsetting the signal in the RGB generating process through the filtering process by the RGB processing unit 15, a similar effect can be achieved by generating the RGB imaging signals by processing 3 or 5 lines and then offsetting one of the resulting signals by the signal interpolation unit.

According to the method described above, it is possible to generate the digital RGB signals representing two picked-up images having different exposure time but the same angle of view.

By coupling the two picked-up images in the manner as shown in the example of FIGS. 5A to 5D, an image signal capable of expressing the detailed parts of the object can be generated which has a wider dynamic range than that unique to the CCD image sensor unit 11. An embodiment of the invention shown in FIG. 1 is explained above.

The CCD image sensor unit 11 according to the invention is not necessarily provided with horizontal CCDs for two lines as long as it is capable of reading signals for one line during one half of the horizontal period of the picked-up image signals output from the image pick-up device.

Also, instead of the CCD image sensor unit used as an image sensor in this embodiment, a similar effect can be achieved by using a C-MOS image sensor unit having substantially the same number of pixels in vertical direction as in the aforementioned embodiment and so configured that the signal is read after reading the charge on a charge storage unit for temporarily storing the charge stored in a photodiode.

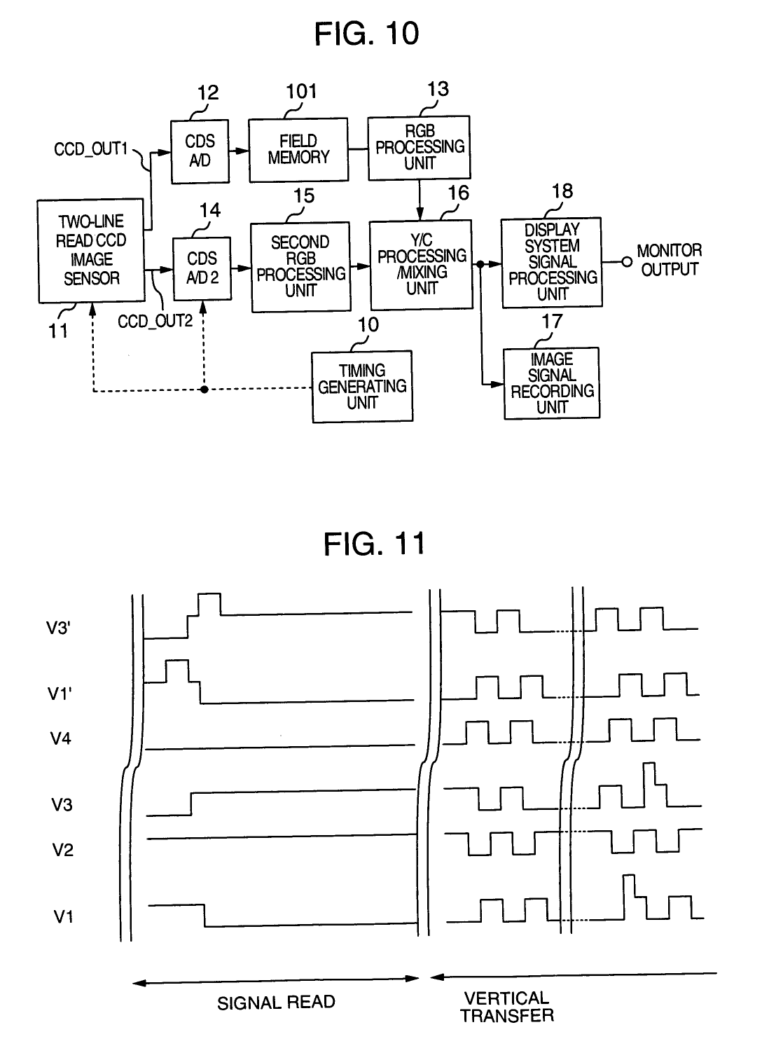

FIG. 10 is a block diagram showing an image pick-up device showing an example of an embodiment of the invention different from the embodiment shown in FIG. 1.

This embodiment is different from the embodiment of FIG. 1 in that a field memory 101 is interposed between the first CDS/AD conversion unit 12 and the first RGB processing unit 13.

According to this embodiment, the provision of the field memory 101 makes it possible to control the image pick-up device in the manner described below.

The exposure time of the imaging signal read from the first output terminal 26 of the CCD image sensor unit 11, i.e. the period before reading the charge on the vertical CCDs 24 is fixed to not longer than one field.

The exposure time of the imaging signal read from the second output terminal 29 is varied in the range of not more than one field to a plurality of fields.

The timing of transferring the charge from the photodiodes 21 to the vertical CCDs 23 is not necessarily the blanking period, but as shown in FIG. 11, any timing can be employed as long as there exists no charge being vertically transferred to the vertical CCD connected to the corresponding photodiode.

The timing of rewriting the contents of the field memory 101 is limited to the timing at which the imaging signal is output from the first output terminal, i.e. the field immediately after reading the charge on the CCD 23.

The picked-up image in the field memory and the picked-up image read from the current CCD image sensor unit 1 are synthesized to produce an image having a wide dynamic range.

In this way, even in the case where the exposure time of the picked-up image subjected to the long-time exposure is extended, the picked-up image subjected to the short-time exposure remains within one field. The image thus read can be reflected in the output image for each field period, and therefore the rate of updating the output image is not adversely affected.

According to this invention, there is provided an image pick-up device having a wide dynamic range in which even in the case where the brightness distribution of an object to be imaged covers a wide range, an image faithfully reproducing an image of the object can be generated.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications which fall within the ambit of the appended claims.

What is claimed is:

1. An image pick-up device comprising:
an image sensor having a plurality of photodiodes arranged in a grid to store the charge by photoelectric conversion of the incident light;
a driving means to drive said image sensor in such a manner as to read at least two imaging signals having different exposure time by differentiating the timing of reading said charge of said photodiodes in according with a corresponding line; and
a signal processing means to generate an image signal by synthesizing and processing at least two imaging signals having different exposure time.

2. An image pick-up device according to claim 1,
wherein said driving means drives said image sensor in such a manner as to read two imaging signals having different exposure time by differentiating the read timing between the odd lines and the even lines of said photodiodes.

3. An image pick-up device according to claim 1,
wherein said driving means drives said image sensor in such a manner as to read a long-time exposed imaging signal having a long exposure time and a short-time exposed imaging signal having a short exposure time from said image sensor, and
wherein said signal processing means generates an image signal by synthesizing and processing a signal representing the low-brightness portion of said long-time exposed imaging signal and a signal representing the high-brightness portion of said short-time exposed imaging signal.

4. An image pick-up device according to claim 1,
wherein said driving means drives said image sensor in such a manner as to read at least two imaging signals having different exposure time within one field period.

5. An image pick-up device according to claim 1,
wherein said image sensor includes a vertical CCD means to vertically transfer the charge read from said photodiodes and a horizontal CCD means for two lines to horizontally transfer the charge transferred by said vertical CCD means, and
wherein said driving means drives said image sensor in such a manner as to read two imaging signals having different exposure time from each of the two lines of said horizontal CCD means.

6. An image pick-up device according to claim 2,
wherein said signal processing means corrects the deviation of the coordinates between an odd line and an even line when synthesizing said odd line and said even line.

7. An imaging method comprising the steps of:
reading a long-time exposed imaging signal having a long exposure time from the odd lines (or the even lines) of an image sensor;
reading a short-time exposed imaging signal having a short exposure time from the even lines (or the odd lines) of said image sensor; and
generating an image signal by synthesizing and processing a signal representing the low-brightness portion of said long-time exposed imaging signal and a signal representing the high-brightness portion of said short-time exposed imaging signal.

8. An image pick-up device comprising an imaging sensor means to convert light into electrical energy, an image sensor driving means for driving said image sensor means, an A/D conversion means to sample the imaging signal read from said image sensor means and converting said imaging signal into a digital imaging signal, and a digital signal processing means to generate a digital image signal by extracting the information on the color and the brightness from said digital imaging signal;
wherein said image sensor means has the number of effective pixels in vertical direction at least twice as many as the number of effective lines of the digital image signal output from said image pick-up device, said image sensor means changing the exposure time in vertical direction; and
wherein said digital signal processing means distributes the imaging signals read from said image sensor means into groups of imaging signals obtained with the same exposure time, and thus generates a digital image signal representing at least two digital images, while at the same time adding said digital image signals to each other.

9. An image pick-up device according to claim 8,
wherein said image sensor means is a CCD image sensor means including a photodiode means to convert light into electrical energy and store the electrical energy as charge, a vertical CCD means to vertically transfer the charge read from said photodiode means, a horizontal CCD means to horizontally transfer the charge transferred thereto from said vertical CCD means, and an output amplifier means to convert the current change generated by the movement of the charge transferred from said horizontal CCD means, into a voltage change.

10. An image pick-up device according to claim 9,
wherein the number of vertical pixels of said CCD image sensor means at least four times as many as the number of vertical pixels for the digital image signal generated by said digital signal processing means,
wherein the timing of reading the stored charge on a vertical CCD from four successive vertical lines of photodiodes is controlled independently, and
wherein said digital image signals representing at least two digital images are generated in such a manner that after reading the charge on the vertical CCDs from the photodiodes to switch the charge storage time of said CCD image sensor means by said CCD image sensor driving means for each two lines of said digital image signals, an imaging signal with the charge stored in mixed pixels having the same storage time is read thereby to obtain imaging signals having different exposure time for each line, said imaging signals being separated for each line having the same exposure time thereby to generate a digital image signal having individual color information and brightness information.

11. An image pick-up device according to claim 8,
wherein said digital image signal having a wide dynamic range further has added thereto an interpolation signal newly generated by signal interpolation to correct the deviation of the coordinates of said two digital image signals on said CCD image sensor means.

12. An image pick-up device according to claim 8,
wherein said CCD image sensor means includes two lines of horizontal CCDs to acquire two imaging signals including an imaging signal having a long exposure time and an imaging signal having a short exposure time at the same time in one horizontal transfer period,
wherein two systems of said digital signal processing means are provided to generate digital image signals representing the brightness information and the color difference information, and
wherein after processing said two imaging signals are processed in parallel, two image signals are added to each other thereby to generate a new digital image signal including two digital image signals having different exposure time superposed one on the other.

13. An image pick-up device according to claim 8,
wherein said image sensor means is a C-MOS image sensor means including a photodiode means to store the electrical energy as a charge converted from light by said image sensor means, a temporary charge storage means associated with said photodiodes arranged in grid form to temporarily store the charge read from said photodiodes, a charge read gate interposed between said temporary charge storage means and an output amplifier, and a gate driving means to control the operation of said charge read gate and the read timing of the charge to said charge read gate, and
wherein the read timing of the charge to said charge read gate is switched in vertical direction thereby to generate at least two images having different exposure time.

14. An image pick-up device comprising an image sensor means to convert light into electrical energy, an image sensor driving means to drive said image sensor means, an A/D conversion means to convert the imaging signal read from said image sensor means into a digital imaging signal, a field memory means to store a field of said digital imaging signal, and a digital signal processing means to generate a digital image signal by extracting the color and brightness information from said digital imaging signal,
wherein said image sensor means has effective vertical pixels at least twice as many as the effective lines of the digital image signal output by said image pick-up device, the exposure time of said image sensor means is switched in vertical direction thereby to carry out the imaging operation with the exposure time of less than one field and the imaging operation with the exposure time of not less than one field, in parallel to each other, said digital signal processing means operating in such a manner that the imaging signal read from said image sensor means is distributed into groups of image signals obtained with the same exposure time thereby to generate digital image signals representing at least two digital images, and those of said digital images which are obtained with the exposure time of not less than one field are stored in said field memory thereby to prepare and add an image signal having the exposure time of less than one field and an image signal having the exposure time of not less than one field to each other.
